(19) United States
(12) Patent Application Publication
(10) Pub. No.: US 2019/0042405 A1
(43) Pub. Date: Feb. 7, 2019

(54) STORING DATA BASED ON WRITING FREQUENCY IN DATA STORAGE SYSTEMS

(71) Applicant: Western Digital Technologies, Inc., Irvine, CA (US)

(72) Inventor: WILLIAM B. BOYLE, LAKE FOREST, CA (US)

(73) Assignee: Western Digital Technologies, Inc., Irvine, CA (US)

(21) Appl. No.: 14/012,958

(22) Filed: Aug. 28, 2013

Related U.S. Application Data
(60) Provisional application No. 61/838,202, filed on Jun. 21, 2013.

(51) Int. Cl. G06F 12/02

(52) U.S. Cl. CPC G06F 12/0253

(57) ABSTRACT

Systems and methods for segregate data in data storage system memory based on writing frequency are disclosed. In some embodiments, infrequently written data is identified and stored in one or more memory regions designated for infrequently written data. Frequently written data is identified and stored in one or more memory regions designated for frequently written data. Garbage collection load can be significantly reduced or eliminated. For example, write amplification of non-volatile solid-state memory is reduced and/or wear of disk heads and other components is reduced. Increased efficiency, longevity, and performance can be obtained.

### CROSS REFERENCE TO RELATED APPLICATIONS

This application claims priority to provisional U.S. Patent Application Ser. No. 61/838,202 (Atty. Docket No. T6662.P), filed on Jun. 21, 2013, which is hereby incorporated by reference in its entirety.

### BACKGROUND

### Technical Field

This disclosure relates to data storage systems for computer systems. More particularly, the disclosure relates to storing data based on writing frequency.

### Description of the Related Art

Data storage systems execute many housekeeping operations in the course of their normal operation. For example, garbage collection is frequently performed on memory regions that may contain both valid and invalid data. When such a region is selected for garbage collection, the garbage collection operation copies valid data within the memory region to new location(s) in memory and then erases or frees the entire region, thereby making the region available for future storage of data. However, performing garbage collection involves substantial overhead, such as increased write amplification in cases when solid state memory is used for storing data. Accordingly, it is desirable to provide more efficient garbage collection mechanisms.

### BRIEF DESCRIPTION OF THE DRAWINGS

Systems and methods that embody the various features of the invention will now be described with reference to the following drawings, in which:

FIG. 1A illustrates a combination of a host system and a data storage system that implements storing data based on writing frequency according to an embodiment of the invention.

FIG. 1B illustrates a combination of a host system and a data storage system that implements storing data based on writing frequency according to another embodiment of the invention.

FIG. 1C illustrates a combination of a host system and a data storage system that implements storing data based on writing frequency according to yet another embodiment of the invention.

FIG. 2 illustrates operation of a data storage system for storing data based on writing frequency according to an embodiment of the invention.

FIG. 3 is a flow diagram illustrating a process of storing data based on writing frequency according to an embodiment of the invention.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions, and changes in the form of the methods and systems described herein may be made without departing from the scope of protection.

### Overview

Data storage systems perform internal system operations, such as garbage collection, to improve performance and longevity. Garbage collection can involve copying valid data stored in a memory region to another memory region, and further indicating that the former memory region no longer stores any valid data. For prioritizing, garbage collection can utilize the amount of invalid data remaining in the memory regions to be garbage collected. However, garbage collection operation involves considerable overhead. For example, when a region that contains both valid and invalid data is being garbage collected, copying valid data to other region(s) in memory can result in significant overhead.

In some cases, with a mix of data corresponding to logical address(es) frequently written or updated by the host system and logical address(es) written or updated by the host system once or infrequently, there is a significant garbage collection load to move or copy the once of infrequently written data to reclaim the space invalidated by the frequently written data. For example, collected workload data shows that about 7 GB of written data each day on a typical personal computer (PC) is for previously written logical addresses (e.g., LBAs). Up to about 1.25 GB of first time written data is programmed each day is mixed in with the 7 GB of recurring LBA writes. Not segregating such data before storing it in data storage system memory can leaves sporadic memory regions of invalid data mixed with valid data. To reclaim these regions, the remaining valid data must be moved during garbage collection. It would be advantageous to segregate frequently (or multiply) written host data from the one time or infrequently written data to reduce garbage collection overhead.

Embodiments of the present invention are directed to storing data based on writing frequency. In one embodiment, data received from the host system is classified based on frequency of writing or updating. Data determined to be frequently written or updated is stored in one or more memory regions designated for storing frequently written data. Data determined to be infrequently written or updated in stored in one or more memory regions designated for storing infrequently written data. Accordingly, data is segregated in memory based on the frequency of writing or updating. Advantageously, such segregation of host or user data based on writing or updating frequency can improve performance of internal memory operations, such as garbage collection. For example, when a region that stores frequently updated data is garbage collected, most or all data stored in the region is likely to be invalid, thereby reducing garbage collection overhead. As another example, one or more regions that store infrequently updated host data are infrequently garbage collected as data in such one or more regions remains valid for a long period of time.

### System Overview

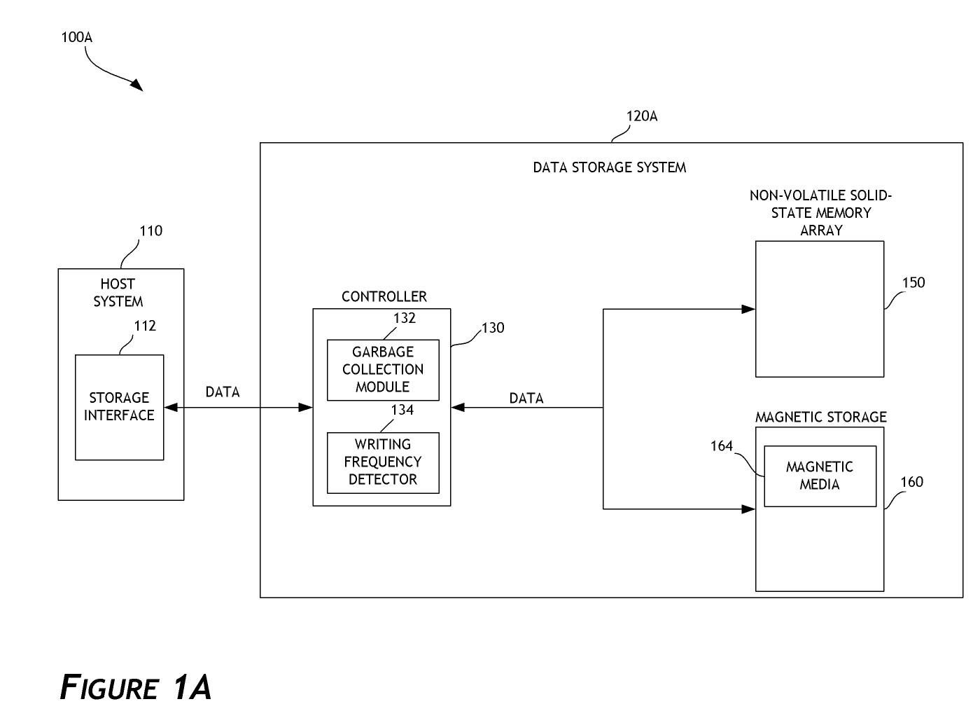

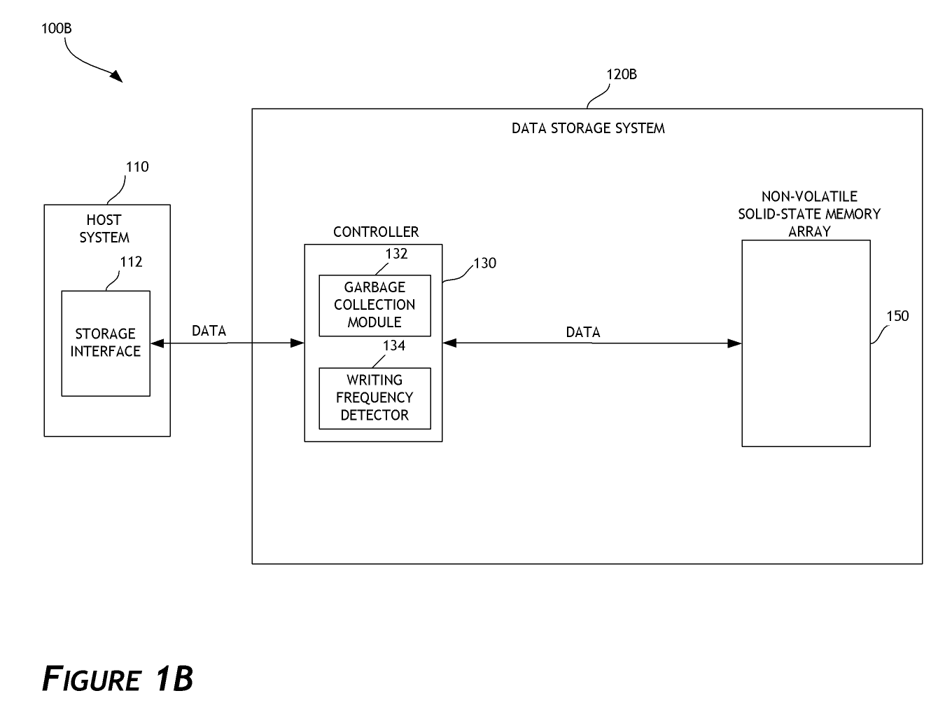

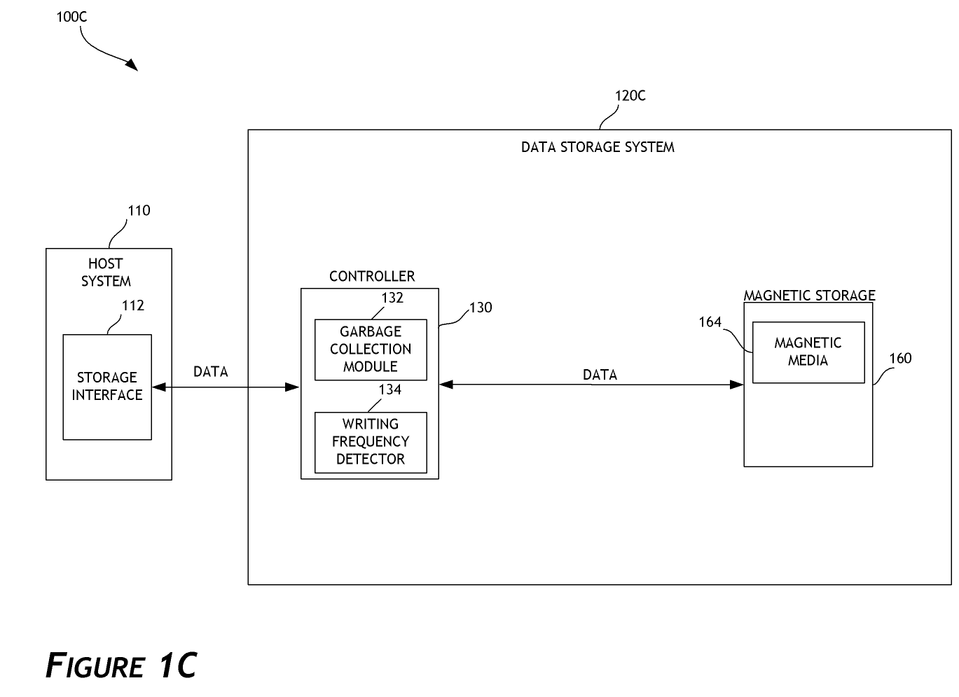

FIG. 1A illustrates a combination 100A of a host system and a data storage system that implements storing data based on writing frequency according to an embodiment of the invention. As is shown, the data storage system 120A (e.g., a hybrid disk drive) includes a controller 130, a non-volatile solid-state memory array 150, and magnetic storage 160, which comprises magnetic media 164. The memory array 150 comprises non-volatile solid-state memory, such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof. The data storage system 120A can further comprise other types of storage. In one embodiment, the solid-state memory array 150 and magnetic media 164 are both non-volatile types of memory but are not homogenous.

The controller 130 can be configured to receive data and/or storage access commands from a storage interface module 112 (e.g., a device driver) of a host system 110. Storage access commands communicated by the storage interface 112 can include write data and read data commands issued by the host system 110. Read and write commands can specify a logical address (e.g., LBA) used to access the data storage system 120A. The controller 130 can execute the received commands in the memory array 150, magnetic storage 160, etc.

Data storage system 120A can store data communicated by the host system 110. In other words, the data storage system 120A can act as memory storage for the host system 110. To facilitate this function, the controller 130 can implement a logical interface. The logical interface can present to the host system 110 data storage system's memory as a set of logical addresses (e.g., contiguous address) where host data can be stored. Internally, the controller 130 can map logical addresses to various physical locations or addresses in the memory array 150 and/or other storage modules. The controller 130 includes a garbage collection module 132 configured to perform garbage collection of data stored in the memory regions of the memory array 150 and/or magnetic storage 160. A memory region can correspond to memory or data allocation unit, such as a block, superblock, zone, etc. The controller 130 also includes a writing frequency detector module 134 configured to determine writing or updating frequency of data received from the host system 110 for storage in the data storage system.

FIG. 1B illustrates a combination 100B of a host system and a data storage system that implements storing data based on writing frequency according to another embodiment of the invention. As is illustrated, data storage system 120B (e.g., solid-state drive) includes a controller 130 and non-volatile solid-state memory array 150. These and other components of the combination 100B are described above. In one embodiment, the data storage system 120B does not include any other memory that is not homogenous with the solid-state memory array 150.

FIG. 1C illustrates a combination 100C of a host system and a data storage system that implements storing data based on writing frequency according to yet another embodiment of the invention. As is illustrated, data storage system 120C (e.g., shingled disk drive which utilizes shingled magnetic recording (SMR)) includes a controller 130 and magnetic storage 160. These and other components of the combination 100C are described above. In one embodiment, the data storage system 120C does not include any other memory that is not homogenous with the magnetic media 164.

In the various embodiments illustrated in FIGS. 1A-1C above, the host system 110 could be a computing system such as a desktop computing system, a mobile computing system, a server, etc. In some embodiments, the host system could be an electronic device such as a digital video recording (DVR) device. In the DVR embodiments, the separation of frequently written data from infrequently written data may be part of a write stream de-interleaving mechanism that segregates incoming data into discrete video streams.

### Storing Data Based on Writing Frequency

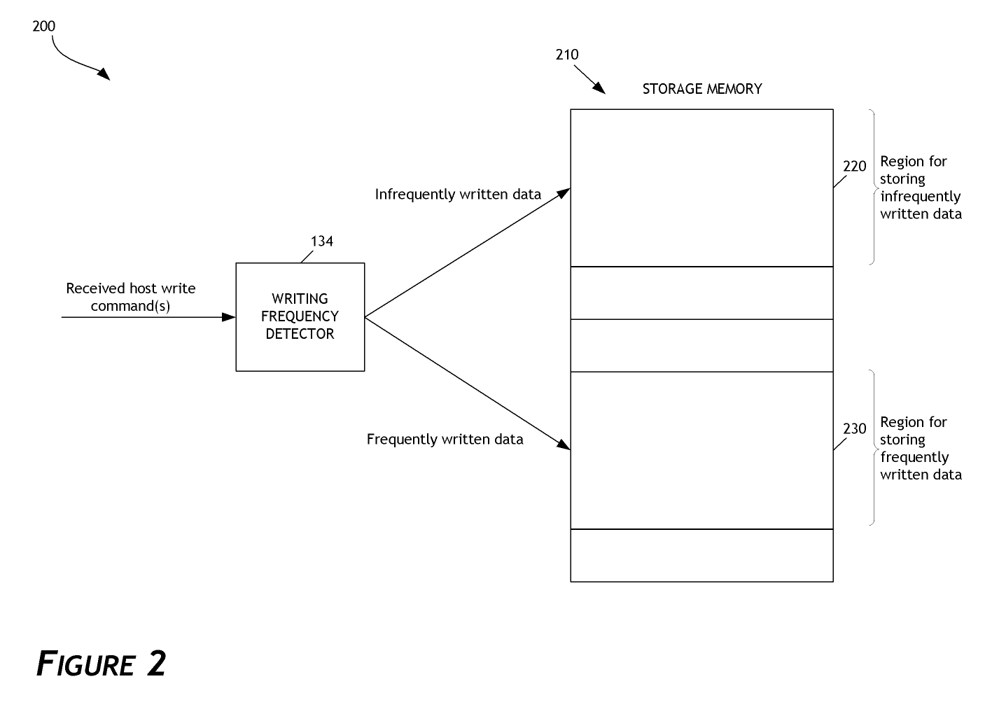

FIG. 2 illustrates operation 200 of a data storage system for storing data based on writing frequency according to an embodiment of the invention. Data is received from the host system 110. In one embodiment, data is received as part of one or more write data commands. The writing frequency detector module 134 determines whether the received host data is frequently or infrequently written or updated data.

Various criteria can be used to make the determination whether data is infrequently or frequently written. In one embodiment, the host system 110 can include information in the write data command whether data to be written in frequently or infrequently written. For instance, when the host system 110 writes operating system (OS) kernel, it may indicate to the data storage system that such data is written once or infrequently.

In another embodiment, the writing frequency detector module 134 treats data that is written for the first time as once or infrequently written data, and treats data that is written or updated more than once as frequently written data. For example, a status indicator or flag corresponding to each logical address or regions of logical addresses can be maintained indicating whether the logical address (or a region of logical addresses) has been written more than once. This flag can be maintained in the translation map (e.g., represented as a bit in a logical-to-physical mapping table) in one embodiment, or maintained in a separate data structure in other embodiments. The flag can be reset to indicate that host data is written for the first time when the host sends an ATA Trim command, SCSI Unmap command, or similar command which indicates that one or more logical addresses no longer store valid data. That is, data written on the next write operation to one or more logical addresses specified by the ATA Trim command should be considered as data written for the first time. In one embodiment, instead of a flag a unique physical address can be used to correspond to the unwritten logical addresses (e.g., the unique physical address can be used in the translation map). The writing frequency detector module 134 can determine whether a logical address (or logical address range) is written for the first time based on whether the logical address has such corresponding unique physical address in the translation map.

In yet another embodiment, data storage system can maintain a write frequency index for each logical address or ranges of logical addresses. This index can be incremented each time the logical address (or the logical address range) is written to (e.g., data stored at the logical address or the range is updated). Data can be classified as frequently written when the index or a combination of indices corresponding to a logical address range crosses a threshold. The index can be reset in response to receiving an ATA Trim command or similar command which indicates that one or more logical addresses no longer store valid data. The frequency determination may also include other factors such as frequency information within hinting information provided by a host system. For example, the host system 110 can provide frequency information as part of a write command (e.g., data to be programmed is frequently written/updated or data to be programmed is infrequently written/updated). As another example, the host system 110 can provide information regarding type of data to be programmed as part of a write command (e.g., operating system data, hibernate data, user data, etc.). The data storage system (e.g., via controller 132) can determine writing frequency based on the provided type of data. For instance, OS kernel is likely to be infrequently written, hibernate data is likely to be overwritten, and so on. The frequency determination in some embodiments may leverage data from frequency tracking mechanisms used in a data caching mechanism in the data storage system. In various embodiments, frequency information determined or provided by various sources can be combined, reconciled, arbitrated between, and the like.

In one embodiment, data storage system memory 210 can be divided into regions, such as groups of blocks, superblocks, zones, etc., designated for infrequently or frequently written data. When the writing frequency detector module 134 makes a determination that received data is infrequently written, this data is written or programmed in a region 220 designated for storing infrequently written data. When the writing frequency detector module 134 makes a determination that received data is frequently written, this data is written or programmed in a region 230 designated for storing frequently written data. Data is segregated and stored in memory based on writing frequency. Infrequently written data is grouped and stored in memory in physical proximity with other infrequently written data. Frequently written data is grouped and stored in memory in physical proximity with other frequently written data. Mixing of infrequently and frequently written data stored in memory is thereby reduced or eliminated. Such segregation enhances the likelihood that portions or entirety of memory regions used for frequently written data will be completely invalidated by subsequent host writes and therefore are self-garbage collected (e.g., no data is moved or copied during garbage collection). These regions immediately become free regions to be reused for future data writes.

In one embodiment, for example, the frequently written data region 230 could be one or more zone(s) in an SMR drive, and the infrequently written data region 220 could be another one or more zone(s) in the SMR drive. In another embodiment, the frequently written data region could be within a solid-state memory and the infrequently written data region could be in magnetic storage (such as in the embodiment shown in FIG. 1A). In some embodiments, the infrequently written data region may be on a remote data storage that is accessible through a network.

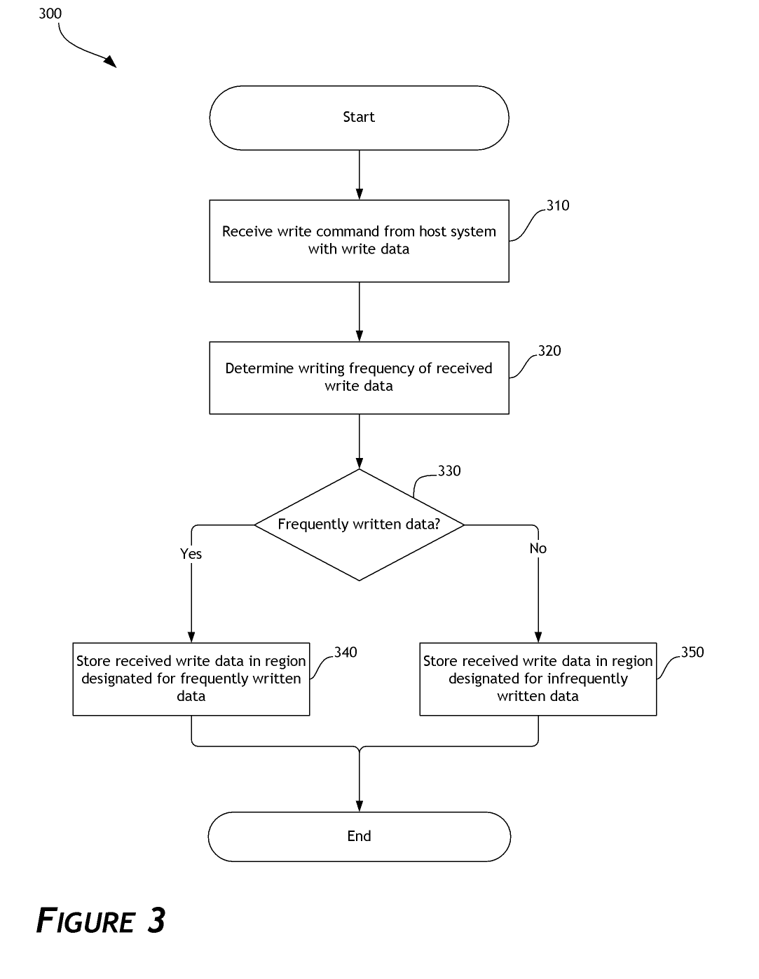

FIG. 3 is a flow diagram illustrating a process 300 of storing data based on writing frequency according to one embodiment of the invention. The process 300 can be executed by the controller 130 and/or the writing frequency detector module 134. The process 300 starts in block 310 where it receives a write command with host data from the host system 110. In block 320, the process 300 determines writing frequency of the received host data. In block 330, the process determines in which memory region to program the received host data. If the data is determined to be frequently written data, in block 340 the process writes the data in a region designated for frequently written data. If the data is determined to be infrequently written data, in block 350 the process writes the data in a region designated for infrequently written data.

### Conclusion

Embodiments of data storage systems disclosed herein are configured to segregate data in memory based on writing frequency. Infrequently written data is identified and stored in one or more memory regions designated for infrequently written data. Frequently written data is identified and stored in one or more memory regions designated for frequently written data. Garbage collection load can be significantly reduced or eliminated. For example, write amplification of non-volatile solid-state memory is reduced, wear of disk heads and other components is reduced, and so on. This results in increased efficiency, longevity, and performance.

### Other Variations

Those skilled in the art will appreciate that in some embodiments, internal or housekeeping operations other than garbage collection can benefit from utilizing disclosed systems and methods. For example, housekeeping operations such as wear leveling, bad block management, memory refresh, and the like can benefit from storing data based on writing frequency. In some embodiments, storing data based on writing frequency can be implemented by any data storage system that uses logical to physical address indirection, such as shingled disk drive, solid state drive, hybrid disk drive, and so on. Additional system components can be utilized, and disclosed system components can be combined or omitted. The actual steps taken in the disclosed processes, such as the process illustrated in FIG. 3, may differ from those shown in the figures. Depending on the embodiment, certain of the steps described above may be removed, others may be added.

While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. For example, the systems and methods disclosed herein can be applied to hard disk drives, hybrid hard drives, and the like. In addition, other forms of storage (e.g., DRAM or SRAM, battery backed-up volatile DRAM or SRAM devices, EPROM, EEPROM memory, etc.) may additionally or alternatively be used. As another example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A data storage system, comprising:
a non-volatile memory comprising a plurality of regions for storing data, wherein the plurality of non-volatile memory regions comprise one or more first non-volatile memory regions and one or more second non-volatile memory regions; and
a controller configured to:
receive a write data command comprising user data from a host system,
determine a writing frequency of the user data, and
select a non-volatile memory region for storing the user data based at least in part on the writing frequency of the user data and store the user data in the selected non-volatile memory region,
wherein:
user data is determined to not exceed a writing frequency threshold when it is written for a first time,
user data is determined to exceed the writing frequency threshold when it is written or updated for a second or subsequent time,
the one or more first non-volatile memory regions are different
from the one or more second non-volatile memory regions, and
the user data that is written for the first time is stored in the one or more second non-volatile memory regions and the user data that is written or updated for the second or subsequent time is stored in the one or more first non-volatile memory regions, the controller further configured to perform garbage collection on the one or more first non-volatile memory regions separately and more frequently than on the one or more second non-volatile memory regions to reduce write amplification associated with performing the garbage collection, and
wherein the user data that is written for the first time is stored only in a magnetic storage and the user data that is written or updated for the second or subsequent time is stored only in a solid state memory.

2. (canceled)

3. The data storage system of claim 1, wherein the controller is further configured to determine that the user data is written for the first time in response to receiving from the host system, prior to receiving the write data command, a command indicating that logical addresses associated with the user data no longer store valid data.

4. The data storage system of claim 1, wherein the controller is further configured to determine that the user data is written for the first time based at least in part on previously generated writing frequency information for the user data, wherein the previously generated writing frequency information comprises one or more status indicators corresponding to one or more logical address associated with the user data, and wherein a status indicator indicates whether the corresponding logical address has been written more than once.

5. The data storage system of claim 4, wherein the controller is further configured to maintain a mapping associating logical addresses with physical addresses in the non-volatile memory, and wherein the mapping comprises the one or more status indicators.

6. The data storage system of claim 1, wherein the controller is further configured to determine that the user data is written for the first time based at least in part on previously generated writing frequency information for the user data, wherein the previously generated writing frequency information comprises one or more write frequency indices for one or more logical addresses associated with the user data, and
wherein the controller is further configured to:
increment the one or more write frequency indices when the one or more logical addresses are written to by the host system; and
determine the writing frequency of the user data based at least in part on the one or more write frequency indices.

7. The data storage system of claim 1, wherein the controller is further configured to determine that the user data is written for the first time based at least in part on previously generated writing frequency information for the user data, and wherein the previously generated writing frequency information comprises hinting information associated with the user data, the hinting information being comprised in the write data command.

8. (canceled)

9. The data storage system of claim 1, wherein the non-volatile memory is homogenous.

10. In a data storage system comprising a non-volatile memory that comprises a plurality of regions for storing data, a method of storing data, the method comprising:
receiving a write data command comprising user data from a host system;
determining a writing frequency of the user data; and
selecting a non-volatile memory region for storing the user data based at least in part on the writing frequency of the user data and storing the user data in the selected non-volatile memory region,
wherein:
user data having writing frequency that exceeds a writing frequency threshold is stored in one or more first non-volatile memory regions designated for storing frequently written data,
user data having writing frequency that does not exceed the writing frequency threshold is stored in one or more second non-volatile memory regions designated for storing infrequently written data,
user data is determined to not exceed the writing frequency threshold when it is written for a first time,
user data is determined to exceed the writing frequency threshold when it is written or updated for a second or subsequent time,
the one or more first non-volatile memory regions are different from the one or more second non-volatile memory regions, and
the user data that is written for the first time is stored in the one or more second non-volatile memory regions and the user data that is written or updated for the second or subsequent time is stored in the one or more first non-volatile memory regions, and garbage collection is performed on the one or more first non-volatile memory regions separately and more frequently than on the one or more second non-volatile memory regions, and
wherein the user data that is written for the first time is stored only in a magnetic storage and the user data that is written or updated for the second or subsequent time is stored only in a solid state memory.

11. (canceled)

12. The method of claim 10, wherein determining that the user data is written for the first time is performed based at least in part on previously generated writing frequency information for the user data, and wherein the previously generated writing frequency information comprises a command, received from the host system, indicating that logical addresses associated with the user data no longer store valid data.

13. The method of claim 10, wherein determining that the user data is written for the first time is performed based at least in part on previously generated writing frequency information for the user data, wherein the previously generated writing frequency information comprises one or more status indicators corresponding to one or more logical address associated with the user data, and wherein a status indicator indicates whether the corresponding logical address has been written more than once.

14. The method of claim 13, further comprising maintaining a mapping associating logical addresses with physical addresses in the non-volatile memory, and wherein the mapping comprises the one or more status indicators.

15. The method of claim 10, wherein determining that the user data is written for the first time is performed based at least in part on previously generated writing frequency information for the user data, wherein the previously generated writing frequency information comprises one or more write frequency indices for one or more logical addresses associated with the user data, and
wherein the method further comprises:
incrementing the one or more write frequency indices when the one or more logical addresses are written to by the host system; and
determining the writing frequency of the user data based at least in part on the one or more write frequency indices.

16. The method of claim 10, wherein determining that the user data is written for the first time is performed based at least in part on previously generated writing frequency information for the user data, and wherein the previously generated writing frequency information comprises hinting information associated with the user data, the hinting information being comprised in the write data command.

17. (canceled)

18. The method of claim 10, wherein the non-volatile memory is homogenous.

19. A data storage system, comprising:
a non-volatile memory comprising a plurality of regions for storing data; and
a controller configured to:
receive a write data command comprising user data from a host system,
determine a writing frequency of the user data,
select a non-volatile memory region for storing the user data based at least in part on the writing frequency of the user data, the controller further configured to select one or more first non-volatile memory regions designated for storing frequently written data in response to determining that the writing frequency of the user data exceeds a writing frequency threshold, and the controller further configured to select one or more second non-volatile memory regions designated for storing infrequently written data in response to determining that the writing frequency of the user data does not exceed the writing frequency threshold, the one or more first non-volatile memory regions being different from the one or more second non-volatile memory regions, and
store the user data in the selected one or more first or second non-volatile memory regions,
wherein user data is determined to not exceed the writing frequency threshold when it is written for a first time, and user data is determined to exceed the writing frequency threshold when it is written or updated for a second or subsequent time, and
wherein the user data that is written for the first time is stored in the one or more second non-volatile memory regions and the user data that is written or updated for the second or subsequent time is stored in the one or more first non-volatile memory regions, the controller further configured to perform garbage collection on the one or more first non-volatile memory regions separately and more frequently than on the one or more second non-volatile memory regions to reduce write amplification associated with performing the garbage collection, and
wherein the user data that is written for the first time is stored only in a magnetic storage and the user data that is written or updated for the second or subsequent time is stored only in a solid state memory.

20. The data storage system of claim 1, wherein the controller is further configured to determine that the user data is written for the first time based at least in part on previously generated writing frequency information for the user data, and wherein the previously generated writing frequency information is included in a write data command indicating that the user data is written once.

21. The data storage system of claim 1, wherein the controller is further configured to determine that the user data is written for the first time based at least in part on previously generated writing frequency information for the user data, and wherein the previously generated writing frequency information comprises a status indicator stored in the controller.

22. A data storage system, comprising:
a non-volatile memory comprising a plurality of regions for storing data; and
a controller configured to:
receive a write data command comprising user data from a host system,
determine a writing frequency of the user data based on whether the user data is written for a first time,
when it is determined that the user data is written for the first time, select a first non-volatile memory region designated for storing infrequently written data and store the user data in the first non-volatile memory region, and
when it is determined that the user data is written or updated for a second or subsequent time, select a second non-volatile memory region designated for storing frequently written data and store the user data in the second non-volatile memory region, wherein the second non-volatile memory region is different from the first non-volatile memory region,
wherein the user data that is written for the first time is stored in the second non-volatile memory region and the user data that is written or updated for the second or subsequent time is stored in the first non-volatile memory region, the controller further configured to perform garbage collection on the first non-volatile memory region separately and more frequently than on the second non-volatile memory region to reduce write amplification associated with performing the garbage collection, and
wherein the user data that is written for the first time is stored only in a magnetic storage and the user data that is written or updated for the second or subsequent time is stored only in a solid state memory.

23. The data storage system of claim 22, wherein the controller is further configured to determine that the user data is written for the first time based on information included in the write data command indicating that the user data is written once.

24. The data storage system of claim 22, wherein the controller is further configured to determine that the user data is written for the first time without counting the number of writes of the user data into the non-volatile memory.

25. The data storage system of claim 1, wherein user data having writing frequency that exceeds the writing frequency threshold is stored in one or more first non-volatile memory regions designated for storing frequently written data, and wherein user data having writing frequency that does not exceed the writing frequency threshold is stored in one or more second non-volatile memory regions designated for storing infrequently written data.

26. The data storage system of claim 1, wherein the data storage system comprises a hybrid disk drive that includes the magnetic storage and the solid state memory.
